(19) United States
(12) Patent Application Publication
(10) Pub. No.: US 2026/0208795 A1
(43) Pub. Date: Jul. 23, 2026

(54) VEHICLE SIDE ASSEMBLY WITH FUNCTIONAL DUCTING

(71) Applicant: Daimler Truck North America LLC, Portland, OR (US)

(72) Inventors: Rajashekar KALARASAIAH, Portland, OR (US); Eric John CARLSON, Portland, OR (US)

(73) Assignee: Daimler Truck North America LLC, Portland, OR (US)

(21) Appl. No.: 19/140,973

(22) PCT Filed: Dec. 15, 2023
(86) PCT No.: PCT/US2023/084439

§ 371 Date: Jun. 18, 2025

Related U.S. Application Data
(60) Provisional application No. 63/434,145, filed on Dec. 21, 2022.

(51) Int. Cl. B62D 21/17; B60K 1/04; B62D 21/02

(52) U.S. Cl. CPC B62D 21/17; B60K 1/04; B62D 21/02

(57) ABSTRACT

Embodiments herein relate to a chassis structure of a vehicle, such as an at least partially electrically-powered vehicle, and a side assembly for use in conjunction with the chassis structure. The chassis may include a set of frame rails spaced apart by rigid cross-members. A set of rigid braces may be coupled to the outer portions of each of the frame rails, and a side assembly may be coupled on each side of the chassis to a respective set of the braces. At least one of the side assemblies can have at least one sealable internal volume, with an inlet port and an outlet port allowing fluid accessibility. The sealable internal volume can be used to store compressed air or coolant used by the vehicle, and other internal volume(s) can be used to house vehicle electrical and/or plumbing lines.

### CROSS-REFERENCE TO RELATED APPLICATIONS AND PRIORITY CLAIM

This PCT application claims priority to U.S. provisional patent app. No. 63/434,145, filed on Dec. 22, 2022, and titled “VEHICLE SIDE ASSEMBLY WITH FUNCTIONAL DUCTING,” the contents of which is incorporated herein by reference in the entirety.

### TECHNICAL FIELD

Embodiments herein relate to a side assembly capable of being coupled to a chassis frame of a vehicle, such as an at least partially electric vehicle, the side assembly including integrated functional ducting.

### BACKGROUND

Traditional vehicles, such as semi-trucks, have an internal combustion engine that is generally located at the front of the vehicle. An electric vehicle or an at least partially electric vehicle (e.g., a battery electric vehicle (BEV), a hybrid electric vehicle (HEV), a plug-in hybrid electric vehicle (PHEV), or a fuel cell electric vehicle (FCEV)) typically has one or more electric motors that receive power from a battery assembly. The battery assembly and electric motors are supplemented with other necessary components, such as a radiator, other cooling components such as cooling pumps and surge tanks, heating components, compressed air tanks, and air compressor(s) among other things. Some of these components require space for routing electrical lines (such as high-voltage (HV) lines, low-voltage (LV) lines) and plumbing lines (such as for cooling at least one battery and/or electrical axle (“eAxle”)).

There is a need to efficiently house these components in a way that effectively utilizes space, allows for easy installation and that is structurally sound.

### BRIEF DESCRIPTION OF THE DRAWINGS

Examples of embodiments herein are described in detail below with reference to the attached drawings figures, wherein:

FIG. 1 illustrates an overall perspective view of a chassis assembly in accordance with embodiments herein;

FIG. 2 illustrates a different perspective view of the chassis assembly of FIG. 1, in accordance with embodiments herein;

FIG. 3 illustrates a sectioned view of one side assembly, in accordance with embodiments herein;

FIG. 4 illustrates an enlarged, partial, perspective view of one end of a side assembly, in accordance with embodiments herein;

FIG. 5 is an enlarged, partial, exploded view of portions of one end of one side assembly, in accordance with embodiments herein;

FIG. 6 is a front elevation view of one end of one side assembly, in accordance with embodiments herein;

FIG. 7 is a perspective view of one side assembly, shown without the remainder of the chassis, in accordance with aspects herein; and

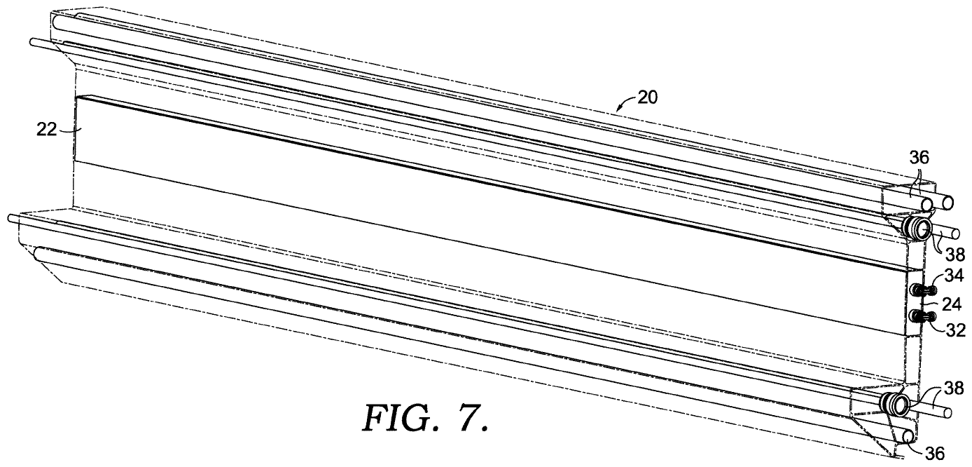

FIG. 8 is an enlarged, partial perspective view of the end of the side assembly of FIG. 7, in accordance with aspects herein.

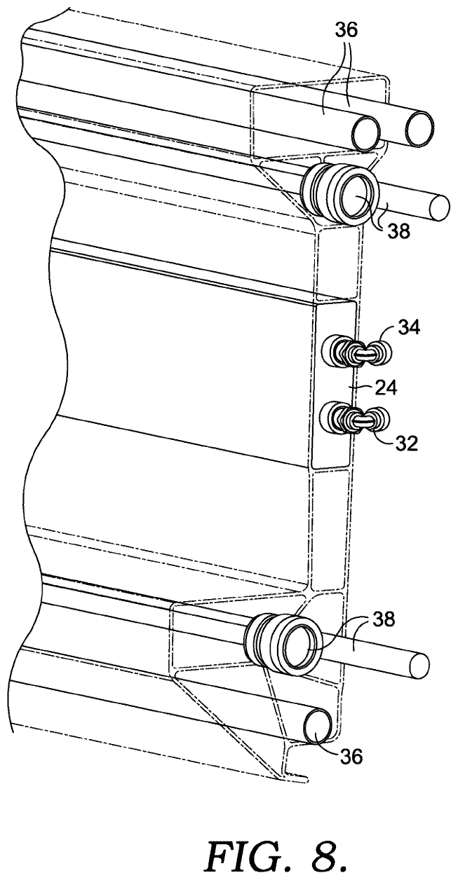

### DETAILED DESCRIPTION

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies.

At a high level, an embodiment as herein disclosed relates to a chassis structure of a vehicle, such as an at least partially electrically powered vehicle, and a side assembly for use on the chassis structure. In some embodiments, the chassis includes a set of frame rails spaced apart by rigid cross-members. In some embodiments, a set of rigid braces are coupled to the outer portions of each of the frame rails, and a side assembly is coupled on each side of the frame rails to a respective set of the braces. At least one of the side assemblies has at least one sealable internal volume, with at least one inlet port and at least one outlet port, e.g., allowing fluid accessibility. In embodiments, a sealable internal volume is capable to store air (e.g., compressed air) usable by the vehicle for various functions (e.g., to assist with vehicle braking, among other things). In additional or alternative embodiments, a sealable internal volume is capable of storing a liquid, e.g., coolant. In embodiments, one or more ducts of a side assembly is/are capable of housing electrical lines (e.g., high voltage (HV) lines, low voltage (LV) lines, and the like). In embodiments, one or more ducts of a side assembly is/are capable of housing plumbing lines (e.g., plumbing lines for battery cooling, eAxle cooling, and the like). In embodiments, one or more ducts of a side assembly is/are capable of housing a separate air storage apparatus (e.g., sealable air tank), or other separate auxiliary storage apparatus. In embodiments, one or more ducts of a side assembly is/are capable of housing one or more battery cells, operable to increase a range of the vehicle.

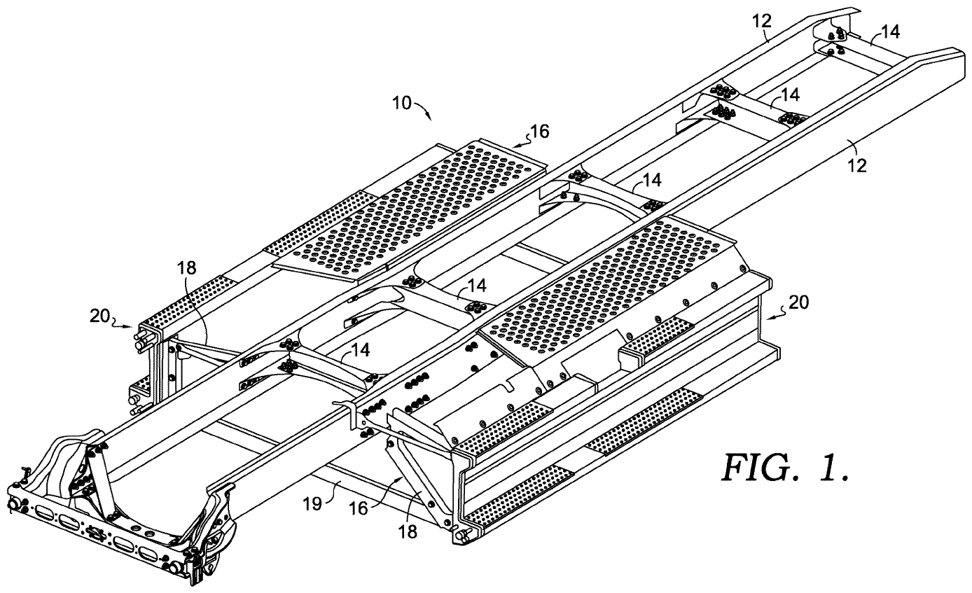

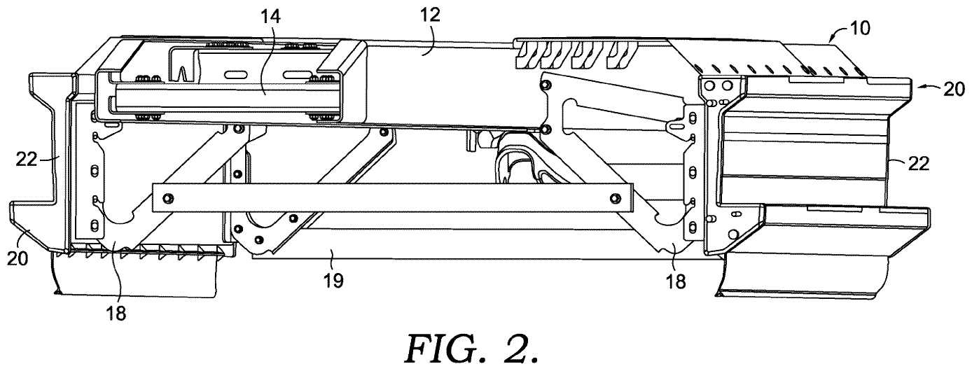

Turning to the figures, FIG. 1 depicts a vehicle chassis 10, such as might be used on an electric (or at least partially electric) truck. As used herein, the terms “electric” vehicle and “at least partially electric” vehicle encompass BEVs, HEVs, PHEVs, FCEVs, and the like. The chassis 10, in some embodiments, includes elongated frame rails 12 that are spaced apart by rigid cross-members 14. As best seen in FIGS. 1 and 2, each frame rail 12 may have a mounting structure 16 coupled thereto, and extending outwardly therefrom. The mounting structure 16, in some embodiments, includes a set of braces 18 that space a side assembly 20 from a corresponding frame rail 12. In some embodiments, at least one rigid cross-member 19 may be coupled to, and extend between, the braces 18, extending under the frame rails 12. In some embodiments, at least two rigid cross-members 19 can be used. In some embodiments, the mounting structure 16 can have a length that is less than the length of the frame rails 12. In embodiments, the length of the mounting structure 16 can be from about 20%-75% of the length of the frame rails.

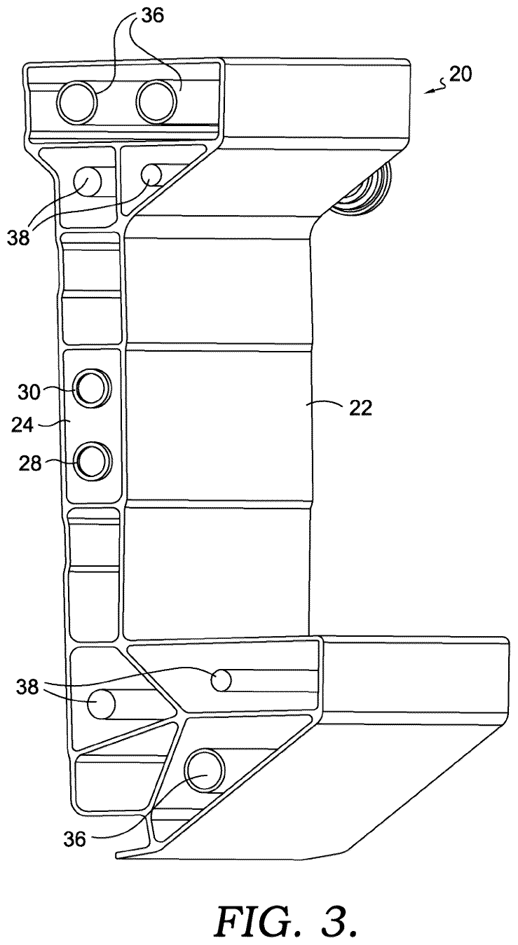

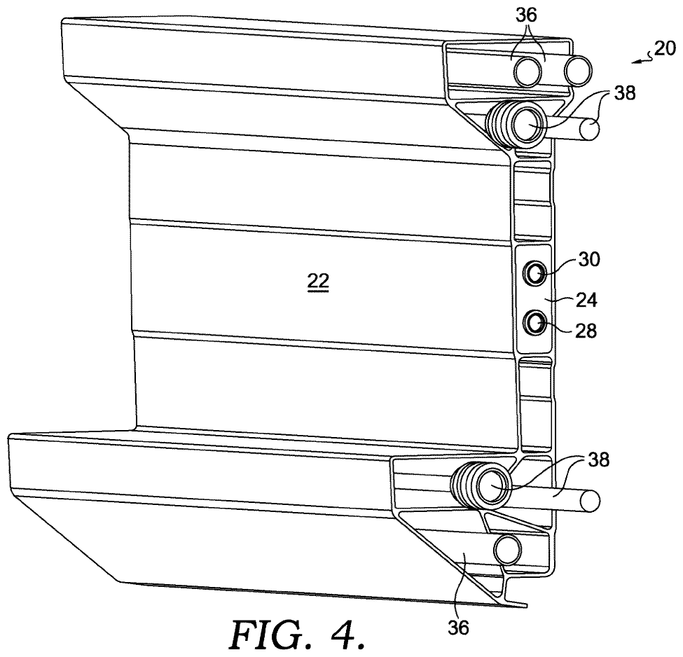

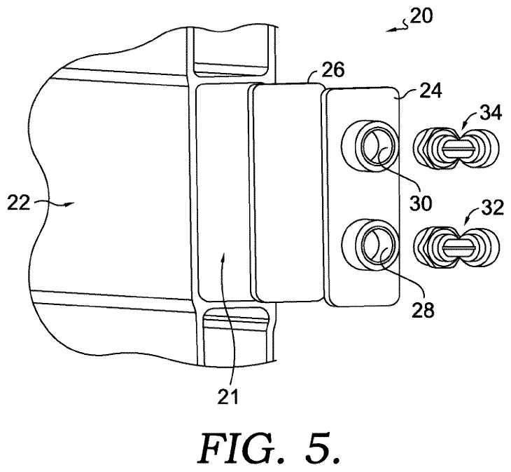

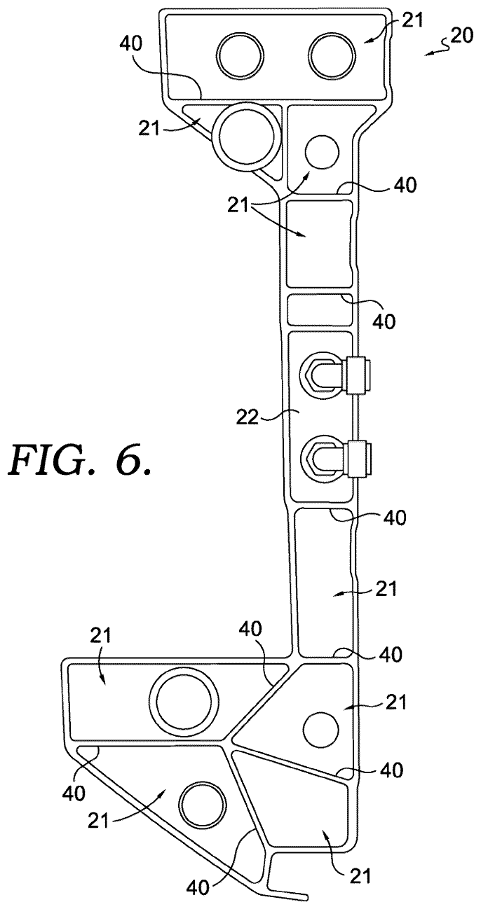

In embodiments, and as shown in FIG. 6, the side assembly 20 includes a number of internal volumes 21 separated by supporting ribs 40. In some embodiments, the side assembly 20 is formed using an extrusion manufacturing process, e.g., an aluminum extrusion process. In additional or alternative embodiments, the side assembly 20 can be formed using one or more of cutting, stamping, welding, extrusion, forging, casting, and the like. In embodiments, the side assembly 20 can be similar to (but inclusive of advantageous additional functionality) the longitudinal member for a commercial vehicle described in co-pending International Application No. PCT/EP2022/082618, the contents of which is incorporated herein by reference in its entirety. For example, in embodiments, a side assembly 20 may at least partially, or fully, overlap with a vehicle battery that is used, at least in part, to propel the vehicle (not shown). Any of the internal volumes may be used as a fluid storage tank, such as the fluid storage tank 22 as seen in FIGS. 3-6. As used herein, the term “fluid” refers to any substance that can flow, and includes but is not limited to gases (e.g., air, oxygen, hydrogen, or the like) and liquids (e.g., water, coolant, or the like). As shown, the fluid storage tank 22 may be somewhat centrally located on the side assembly 20. However, as seen in FIG. 6, the side assembly 20 contains other internal volumes 21 that could additionally or alternatively be used as a fluid storage tank 22. The internal volume 21 used as fluid storage tank 22 can be seen in FIG. 5. As best seen in FIG. 5, an end plate 24 may be coupled to the end of the side assembly 20, e.g., such as through welding, brazing, soldering, riveting, metal stitching, use of fasteners, or the like, to seal each end of one of the internal volumes 21 (the weld represented by line 26 in FIG. 5). In some embodiments, a separate, sealable fluid storage tank could be placed within the internal volume 21 on the side assembly 20. The end plate 24 may include at least one inlet port 28 and at least one outlet port 30. As shown in FIG. 5, an inlet valve 32 may be coupled to the inlet port 28 to supply the fluid storage tank 22 with the desired fluid (e.g., compressed air). In embodiments where the fluid storage tank 22 holds compressed air, the inlet valve 32 may be coupled to an air compressor (not shown). Similarly, the outlet port 30 may be coupled to an outlet valve 34. The outlet valve 34 may be coupled to a component or components for which operation depends on some amount of the fluid held in the fluid storage tank 22. For example, in embodiments where the fluid storage tank 22 holds compressed air, outlet valve 34 may be coupled to a manifold, and/or directly to other components needing compressed air (such as the braking system). While only one inlet valve 32 and one outlet valve 34 are shown, the fluid storage tank (e.g., fluid storage tank 22) of the side assembly 20 may have additional inlet and outlet ports and valves. In embodiments, more than one of the internal volumes 21 can be used to store fluid. In embodiments, at least two internal volumes 21 are used, and store a same fluid (e.g., at least two internal volumes may store air). In embodiments, at least two internal volumes 21 are used and store different fluids. For example and without limitation, at least one internal volume may store air, and another internal volume may store a fluid other than air (e.g., coolant).

The others of the internal volumes 21 can be used to house, enclose, or guide electrical or plumbing lines for the vehicle. In some embodiments, the internal volumes 21 may house and protect plumbing lines 36 that may supply cooling liquids, for example, such as might be needed to cool batteries associated with the vehicle or to cool an eAxle of the vehicle. Additionally or alternatively, the internal volumes 21 may be used to house and protect electrical lines 38, such as HV and LV electrical lines.

In some embodiments, the side assembly 20 on one side of the chassis 10 can mirror and/or generally be the same as the side assembly 20 on the opposite side of the chassis 10. In some embodiments, the side assembly 20 on one side of the chassis 10 can be configured differently than the side assembly on the opposite side of the chassis 10. For example and without limitation, a side assembly on one side of the chassis can include an internal volume that holds air (or houses a separate sealable air tank capable of holding compressed air), and a side assembly on another side of the chassis can include an internal volume that holds coolant (or houses a separate sealable coolant tank). In embodiments, more than one of the internal volumes 21 could be used as the fluid storage tank 22 to provide additional storage volume (e.g., of a same fluid). In some embodiments, the internal volumes 21 used as a fluid storage tank 22 are in fluid communication with one another (such as by making or forming holes through supporting ribs 40 that separate adjacent internal volumes 21). In such an example, end plate 24 may be sized to appropriately cover all of the internal volumes 21 in fluid communication with one another to effectively form a larger internal volume. Alternatively, a separate end plate may be secured to the end of each internal volume 21 desired to be used as a fluid storage tank. Each fluid storage tank 22 may range in storage capacity, e.g., in embodiments, being sized to hold between about 3-9 gallons (or between about 11-35 liters in some instances).

By utilizing one or more of the internal volumes 21 within the side assembly 20 as the fluid storage tank 22, space formerly needed for external fluid storage tanks can be made available for other uses. For example, large cylindrical air tanks are typically used to store compressed air, and a space had to be provided for such tanks, such as by mounting them to the frame rails 12, extending inwardly. By utilizing one or more of the internal volumes 21 of the side assembly 20 as a fluid storage tank 22 (e.g., to store compressed air), a lighter solution is achieved to store the fluid (because most of the material/structure(s) needed may already be present on the vehicle). The fluid storage tank 22 may only introduce the weight of the end plate 24 to the chassis 10, because the fluid storage tank 22 can leverage existing internal volumes 21 within the side assembly 20. In embodiments, by utilizing space within the side assembly 20 as a fluid storage tank, the use of separate storage tanks (e.g., separate air tanks and associated mounting brackets on the frame rails) may not be needed, and thus space, weight, and structural complexity can be reduced. In additional or alternative embodiments, by using other of the internal volumes 21 to house the plumbing lines 36 and the electrical lines 38, additional space savings may be achieved. Additionally, use of the one or more internal volume(s) 21 to enclose and route plumbing lines 36 and/or electrical lines 38 may provide added protection to the plumbing lines 36 and the electrical lines 38. It is also within the scope of this disclosure that one or more of the internal volumes 21 can serve to house a battery cell, or a plurality thereof. For example each side assembly may be capable to house one or more battery cells, in addition to, or alternative to, other options including but not limited to the storage of fluid(s), electrical line(s), plumbing line(s), and the like.

In addition, the aforementioned side assembly configurations can enable manufacturing simplicity and efficiency by reducing the number of structures to be produced, assembled, and/or integrated onto a chassis, e.g., the chassis 10, for supporting various vehicle systems, components, and consumables (e.g., compressed air, fluid, and the like). This also provides a space efficient design that leaves additional room for other vehicle elements or features, e.g., batteries, electric motors, storage systems, and the like, thereby increasing the utility and capability of an associated vehicle.

In embodiments, a side assembly for a vehicle, that is configured to at least partially enclose a fluid storage system and/or conduits or ducting for the same, is provided. In embodiments, a pair of opposite but generally mirrored in configuration side assemblies is also provided.

In embodiments, a vehicle that includes one or a pair of opposite side assemblies each configured to at least partially enclose a fluid storage system and/or conduits and/or ducting for the same, is provided.

In embodiments, a method of manufacturing a side assembly or a pair of opposite side assemblies for a vehicle, each configured to at least partially enclose a fluid storage system and/or conduits and/or ducting for the same, is provided.

In embodiments, a method of integrating or retrofitting one or a pair of opposite side assemblies for a vehicle, such that each side assembly is configured to at least partially enclose a fluid storage system and/or conduits and/or ducting for the same, is provided.

In embodiments, a method of operating a vehicle, e.g., a freight truck, e.g., an at least partially electrically-powered freight truck, that includes one, or a pair of, side assembles each configured to at least partially enclose a fluid storage system and/or conduits and/or ducting for the same, is provided.

In embodiments, any of the side assemblies or particular configurations thereof described herein can be provided as a kit configured to be implemented onto a vehicle, e.g., a freight truck, e.g., an at least partially electrically-powered freight truck, in place of an existing side assembly.

The following clauses represent example aspects of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are illustrative in nature and are not limiting.

Clause 1. A side assembly for a vehicle, comprising: a first elongated structural member capable of being coupled to, and spaced apart from, a first frame rail of a chassis of the vehicle, the first elongated structural member comprising: an elongated rigid frame having a plurality of internal volumes, wherein at least one of the plurality of internal volumes comprises a sealable internal volume capable of storing a fluid.

Clause 2. The side assembly of clause 1, wherein the fluid is coolant.

Clause 3. The side assembly of any of clauses 1-2, wherein the fluid is compressed air.

Clause 4. The side assembly of any of clauses 1-3, wherein at least one of the plurality of internal volumes is open to atmosphere at a first end and a second end of the side assembly, the first end proximal to a cab of the vehicle and the second end distal to the cab of the vehicle.

Clause 5. The side assembly of any of clauses 1-4, wherein at least one of the plurality of internal volumes open to atmosphere at the first and the second end of the side assembly is configured to house one or more vehicle electrical lines, the one or more electrical lines selected from high voltage and low voltage lines.

Clause 6. The side assembly of any of clauses 1-5, wherein at least one of the plurality of internal volumes open to atmosphere at the first and the second end of the side assembly is configured to house one or more coolant lines.

Clause 7. The side assembly of any of clauses 1-6, further comprising: a second elongated structural member capable of being coupled to, and spaced apart from, a second frame rail of the chassis, the second elongated structural member comprising an elongated rigid frame having a plurality of internal volumes.

Clause 8. The side assembly of any of clauses 1-7, wherein at least one of the plurality of internal volumes of the second elongated structural member comprises a sealable internal volume.

Clause 9. The side assembly of any of clauses 1-8, wherein the sealable internal volume associated with the first side assembly and/or the second side assembly comprises at least one inlet port and at least one outlet port, the inlet port(s) and outlet port(s) comprising respective inlet/outlet valves.

Clause 10. The side assembly of any of clauses 7-9, wherein the first and the second elongated structural members are connected via at least one brace that extends from the first elongated structural member to the second elongated structural member underneath the first and the second frame rails of the chassis.

Clause 11. The side assembly of any of clauses 1-10, wherein the first and the second elongated structural members are connected via a first brace and a second brace that each extend from the first elongated structural member to the second elongated structural member underneath the first and the second frame rails of the chassis; and wherein the first brace extends from a front end of the first elongated structural member to a front end of the second elongated structural member, and the second brace extends from a rear end of the first elongated structural member to a rear end of the second elongated structural member.

Clause 12. A chassis for an electric or at least partially electric vehicle, the chassis comprising: a pair of spaced apart frame rails; a plurality of rigid cross members coupled between the pair of frame rails; a first elongated structural member spaced apart from and coupled to one of the pair of frame rails; a second elongated structural member spaced apart from and coupled to another of the pair of frame rails; wherein each of the first and the second elongated structural members comprise a plurality of internal volumes; and wherein at least one of the plurality of internal volumes comprises at least one of a sealable internal volume capable to house a fluid for use in conjunction with operation of the vehicle.

Clause 13. The chassis clause 12, wherein the sealable volume is sealable by way of one or more end plates and associated inlet and outlet ports, said inlet and outlet ports comprising corresponding inlet and outlet valves.

Clause 14. The chassis of any of clauses 12-13, wherein the fluid is selected from hydrogen gas, compressed air, and coolant.

Clause 15. The chassis of any of clauses 12-14, wherein the first elongated structural member and the second elongated structural member are coupled to one another by way of a plurality of rigid braces that extend between said elongated structural members and underneath the pair of frame rails.

Clause 16. The chassis of any of clauses 12-15, wherein one or more of the plurality of internal volumes comprises an internal volume that is open to atmosphere on one or both ends of an associated elongated structural member.

Clause 17. The chassis of any of clauses 12-16, wherein an internal volume open to atmosphere on one or both ends of an associated elongated structural member is configured to house one or more of electrical line(s), and plumbing line(s).

Clause 18. An at least partially electric vehicle, comprising: the chassis according to any one of clauses 12-17.

Clause 19. The vehicle of clause 18, wherein the vehicle is selected from the group consisting of a battery electric vehicle, a plug-in hybrid electric vehicle, a hybrid electric vehicle, and a fuel cell electric vehicle.

Clause 20. The vehicle of any of clauses 18-19, wherein the vehicle is propelled at least in part via an onboard energy storage device; and wherein the first and the second elongated structural members frame the onboard energy storage device on two sides.

Embodiments of the present disclosure have been described with the intent to be illustrative rather than restrictive. Alternative embodiments will become apparent to those skilled in the art that do not depart from its scope. A skilled artisan may develop alternative methodologies of implementing the aforementioned improvements without departing from the scope of the present disclosure. It will be understood that certain features and sub-combinations are of utility and may be employed without reference to other features and sub-combinations and are contemplated within the scope of the claims. Not all steps listed in the various figures need be carried out in the specific order described.

1. A side assembly for a vehicle, comprising:
a first elongated structural member capable of being coupled to, and spaced apart from, a first frame rail of a chassis of the vehicle, the first elongated structural member comprising:
a first elongated rigid frame having a first plurality of internal volumes,
wherein at least one of the first plurality of internal volumes comprises a first sealable internal volume capable of storing a fluid.

2. The side assembly of claim 1, wherein the fluid is coolant.

3. The side assembly of claim 1, wherein the fluid is compressed air.

4. The side assembly of claim 1, wherein at least one of the first plurality of internal volumes is open to atmosphere at a first end and a second end of the side assembly, the first end proximal to a cab of the vehicle, and the second end distal to the cab of the vehicle.

5. The side assembly of claim 4, wherein at least one of the first plurality of internal volumes open to the atmosphere at the first end and the second end of the side assembly is configured to house one or more vehicle electrical lines, the one or more vehicle electrical lines each comprising high-voltage lines or low-voltage lines.

6. The side assembly of claim 4, wherein at least one of the first plurality of internal volumes open to the atmosphere at the first end and the second end of the side assembly is configured to house one or more coolant lines.

7. The side assembly of claim 1, further comprising a second elongated structural member capable of being coupled to, and spaced apart from, a second frame rail of the chassis, the second elongated structural member comprising a second elongated rigid frame having a second plurality of internal volumes.

8. The side assembly of claim 7, wherein at least one of the second plurality of internal volumes of the second elongated structural member comprises a second sealable internal volume.

9. The side assembly of claim 8, wherein the second sealable internal volume comprises at least one inlet port and at least one outlet port, each inlet port and each outlet port comprising corresponding inlet/outlet valves.

10. The side assembly of claim 7, wherein the first and the second elongated structural members are connected via at least one brace that extends from the first elongated structural member to the second elongated structural member underneath the first and the second frame rails of the chassis.

11. The side assembly of claim 10, wherein the first and the second elongated structural members are connected via a first brace and a second brace that each extend from the first elongated structural member to the second elongated structural member underneath the first and the second frame rails of the chassis; and wherein the first brace extends from a first front end of the first elongated structural member to a second front end of the second elongated structural member, and wherein the second brace extends from a first rear end of the first elongated structural member to a second rear end of the second elongated structural member.

12. A chassis for an electric or at least partially electric vehicle, comprising:
a pair of spaced-apart frame rails;
a plurality of rigid cross-members coupled between the pair of spaced-apart frame rails;
a first elongated structural member spaced apart from, and coupled to, a first one of the pair of spaced-apart frame rails; and
a second elongated structural member spaced apart from, and coupled to, a second one of the pair of spaced-apart frame rails,
wherein each of the first and the second elongated structural members comprises a plurality of internal volumes, and
wherein at least one of the plurality of internal volumes comprises a sealable internal volume capable of storing a fluid for use in connection with operation of the vehicle.

13. The chassis of claim 12, wherein the sealable internal volume is sealable through attachment of one or more end plates with associated inlet and outlet ports, the inlet and outlet ports comprising corresponding inlet and outlet valves.

14. The chassis of claim 11, wherein the fluid comprises one of hydrogen gas, compressed air, and coolant.

15. The chassis of claim 12, wherein the first elongated structural member and the second elongated structural member are coupled to one another with a plurality of rigid braces that extend between the first and second elongated structural members and underneath the pair of spaced-apart frame rails.

16. The chassis of claim 12, wherein one or more of the plurality of internal volumes comprises an internal volume that is open to atmosphere on one or both ends of an associated elongated structural member.

17. The chassis of claim 16, wherein the internal volume open to the atmosphere on the one or both ends of the associated elongated structural member includes one or more of electrical line(s) and plumbing line(s).

18. An at least partially electric vehicle, comprising:
the chassis according to claim 12.

19. The at least partially electric vehicle of claim 18, wherein the vehicle comprises a battery electric vehicle, a plug-in hybrid electric vehicle, a hybrid electric vehicle, or a fuel cell electric vehicle.

20. The at least partially electric vehicle of claim 18, wherein the vehicle is propelled at least in part by an onboard energy storage device; and wherein the first and the second elongated structural members enclose the onboard energy storage device on two sides.
